(19) United States
(12) Patent Application Publication
(10) Pub. No.: US 2008/0272102 A1
(43) Pub. Date: Nov. 6, 2008

(54) Heated handle construction

(76) Inventor: Robyn J. Farrington, Westfield, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/893,859

(22) Filed: Aug. 17, 2007

Related U.S. Application Data
(63) Continuation-in-part of application No. 11/800,390, filed on May 4, 2007.

(51) Int. Cl. H05B 3/34

(52) U.S. Cl. 219/201

(57) ABSTRACT

A heated handle construction for integration into a cane, walker, walking stick, snow shovel, baby carriage or stroller has an integral stem portion constructed with a handle portion, a central shaft, and a bearing member. The handle is thermally insulating, wound with wrapped flexible heating tape or strip, and connected through an on-off switch to a plurality of batteries present in a hollow cavity of the central shaft. Optionally, a thermally insulating foam tape is inserted between the heating element and the thermally insulating handle. An infrared reflector placed below the heating element directs heat to the user's hand. The heating element raises the temperature of the cane, walking stick, walker, snow shovel, or baby carriage handle, radiating heat to the hand of the user, thereby providing a comfortable grip during use in wintry weather.

### RELATED U.S. APPLICATION DATA

This application is a continuation-in-part of co-pending U.S. patent application Ser. No. 11/800,930, filed May 4, 2007, the entire disclosure of which is incorporated by reference herein as if being set forth in its entirety.

### BACKGROUND OF THE INVENTION

1. Field of the Invention

The present invention relates to hand warming apparatus associated with handles of implements appointed for low-temperature use; and more particularly, to a heated handle construction for canes, walkers, walking sticks, snow shovels, baby carriages, and strollers, wherein power means within a stem portion of the device energizes heating means that warm a handle or like portion of the device appointed to be held or gripped by the user.

2. Description of the Prior Art

The handles of a cane, walker, walking stick, snow shovel, baby carriage and stroller is generally the first element contacted when the device is placed in service. Oftentimes, and particularly during the winter months, these handles become cold and uncomfortable to touch, or to grip for an appreciable period of time. Many patents address issues related to warming handles of various devices, such as fishing rods, ski poles, motorcycle handles, and the like. These patents do not address warming the handles of canes, walkers, walking sticks, snow shovels, baby carriages and strollers using self-contained electrical power accessed through a user-operated switch.

Various devices have been provided that disclose heated fishing rods. For example: U.S. Pat. No. 744,789 to Fliess discloses a heated fishing rod including a handle heated by electrical wires powered by an external battery; however the polished porcelain surface of the fishing rod handle is not a metal, and does not reflect infrared radiation. Moreover, power is supplied from batteries, which are not contained within the fishing rod or its handle. U.S. Pat. No. 3,164,921 to Mavrakis discloses a heated fishing rod wherein fishing line guides are heated by battery power to prevent ice freezing over the fishing line. A plurality of rods through which the fishing line is passed are heated by battery power. Though the heated rods pass through the handle, the thick insulation of the handle substantially prevents any of the heat from reaching the hand of the user. U.S. Pat. No. 4,598,192 to Garrett discloses an electrically heated handle for a fishing rod and teaches a conductive aluminum shell contacting the hand of the fisherman with an insulating Steatite body is inserted within the aluminum thermally conductive shell. A heating coil, powered by an external battery, is wound in a pair of passages on the outer surface of the insulating Steatite body. The coil first heats the insulating Steatite body, which is a poor conductor. Heat and thermal contact between the aluminum shell and the insulating Steatite body raises the temperature of the aluminum shell handle. Due to the insulating character of the Steatite body, the handle stays warm for a long time, even when the heating coil is switched off. Since the heating coil is in very close proximity with the aluminum shell, the coil has a tendency to become short circuited thereby. Due to the poor heat conduction character of the Steatite body, the heating coil may overheat and burn out. At any rate, the heating of the insulating body is very slow, with the result that heat delivery to the hand is not robust. The fishing rod handle disclosed by the '192 patent would not be suitable for canes, walkers, walking sticks, snow shovels, baby carriages and strollers. Moreover, the battery for heating the heating coil is external and is not contained within the handle. U.S. Pat. No. 5,517,786 to Peissig discloses a heated fishing rod having of a foam handle, plastic cylinder, plastic coated heat tape, rechargeable battery pack, on/off toggle button, electronic regulator, reel holder, metal housed ceramic eyes, and tapered rod shaft. Within the foam handle is a plastic cylinder that houses the battery pack and fixtures for electrical contacts. The rechargeable batteries in the handle heat the fishing rod at the handle and at the ceramic eyelets, providing heat to the hand and to the ceramic eyelets for easy movement of the fishing line, when turned on by a switch. The heat is provided by a plastic coated heating tape that is wrapped in the required locations. The process by which the electrical circuit heats the wrapped tape is unclear. The device disclosed by the '786 patent is a heated fishing rod. No disclosure is contained there in concerning heated handles for canes, walkers, walking sticks, snow shovels, baby carriages and strollers.

Other heated devices disclosed by prior art workers include heated umbrellas; but these umbrella devices are not equipped with heated handles. For Example: U.S. Pat. No. 1,683,270 to Taylor et al. discloses a radiation receiving conductor via an umbrella having a wound coil receiving electromagnetic radio waves. U.S. Pat. No. 2,496,501 to Staunton et al. discloses an umbrella wherein the cover of the umbrella has a novel, inexpensive, folding structure. U.S. Pat. No. 2,757,679 to Rivkin et al. discloses an emergency umbrella having a small number of parts and a water repellant canopy. These heated umbrella devices do not suggest use of a heated handle for canes, walkers, walking sticks, snow shovels, baby carriages and strollers.

Additionally, U.S. Pat. No. 3,739,792 to Holland discloses an umbrella with heat generating means. Electric heating elements located in ribs of the umbrella framework heat the volume of air present under the umbrella canopy. Electrical heaters in the vertical column are powered by a plurality of batteries contained within the vertical column or carried elsewhere in a pocket or briefcase. The heating elements in the vertical column heat the surrounding air, which rises upwards. The heaters do not therefore warm the handle of the umbrella at the local where the user's hands make contact therewith, and does not provide a heated handle for canes, walkers, walking sticks, snow shovels, baby carriages and strollers. U.S. Pat. No. 4,978,110 to Lin et al. discloses a fire protection umbrella having an asbestos cloth covered with a flame retardant paint, and with ceramic tiles or hollow tubes. An umbrella cover is connected to strong umbrella ribs fashioned to function as a parachute. The handle of the fire retardant umbrella is not heated. U.S. Pat. No. 5,625,960 to Fujita discloses a unit for removing rainwater from umbrellas including an umbrella insertion portion into which an umbrella that is wet with rain is inserted via a plurality of brushes and forced air circulation. This disclosure does not contemplate an umbrella having a heated handle, let alone means for heating handles of canes, walkers, walking sticks, snow shovels, baby carriages and strollers. U.S. Pat. No. 5,823,212 to Allen discloses a stadium umbrella having a cover composed of a transparent, as opposed to an opaque, material. Coverage is provided for the torso of the user. The umbrella comprises a transparent cover through which the user can see a sports event. A motor driving a wiper for the umbrella is powered by batteries contained in the umbrella's handle or shaft. The handle of the umbrella is not heated. Batteries in the umbrella shaft drive the wiper motor; but do not supply power to a handle heater. A heated handle integrated into canes, walkers, walking sticks, snow shovels, baby carriages and strollers is not disclosed. U.S. Pat. No. 7,003,217 to Bachinski et al. discloses an infrared heating system for patio umbrellas wherein a plurality of infrared heaters are mounted on the cross support members, and additionally on the support stand, provide infrared heat to the users under the umbrella. The handle of the umbrella is not heated, and the reference does not provide heated handles for canes, walkers, walking sticks, snow shovels, baby carriages and strollers. Foreign Patent Publication No EP1504689 to Bowyer et al. discloses an umbrella adapted to incorporate a heater attached to the ribs of the umbrella and heats the users within the canopy of the umbrella, however the handle of the umbrella is not provided with a heater and this disclosure does not disclose a heated handle in canes, walkers, walking sticks, snow shovels, baby carriages and strollers. Foreign Patent Publication No JP4067802 to Naonori discloses an umbrella handle containing a heating element that releases heat during oxidation. An airtight bag contains the product subject to oxidation. An air hole is opened to allow oxidation to occur and thus cause heat production. This bag, containing an oxidizable product, forms a separate element and is therefore not integral with the umbrella. The handle of the umbrella is not heated by electrical wires or strip, and a heated handle for canes, walkers, walking sticks, snow shovels, baby carriages and strollers is not disclosed.

Further heated devices provided deal with heated hand grips for motorcycles, golf clubs and other apparatuses. These heated hand grips do not provide a heated handle integrated within a cane, walker, walking stick, baby carriage and stroller, and/or snow shovel. For Example: U.S. Pat. No. 5,834,734 to Ogata discloses a handgrip with built-in heater. A cylindrical rubber handgrip body is connected to a handle bar pipe of, for example, a motor cycle. The rubber handgrip is slid over the handlebar of the motorcycle. A heating element is embedded in the rubber handgrip and is powered by an external battery, which constitutes the battery in the motorcycle. The handgrip with the built in heater is not integral to the motorcycle handle; but is instead slid-on over the handlebar. The '734 patented device is not used to heat the handles of canes, walkers, walking sticks, snow shovels, baby carriages and strollers. Other similar motorcycle slip-on handle heaters are disclosed by U.S. Pat. Nos. 5,735,037, 5,626,780 and 5,613,407.

U.S. Pat. No. 6,998,576 to Marquis discloses an electrically heated hand grip that is suited for handles of sports apparatus such as a golf club. An electrically heated hand grip, primarily for golf clubs, is slipped over the golf club so that the inner sleeve member bonds and is attached to the golf club by an adhesive. This requires the inner sleeve member to be straight and the golf club to have a straight cylindrical character. Such a device is not useful for handles of canes, walkers, walking sticks, snow shovels, baby carriages and strollers, which generally have a curved configuration. The heated hand grip is a separate device that is slipped onto a golf club by being inserted over a golf club handle and bonded thereto by adhesive. The heated hand grip does not provide a heated handle integrated within a cane, walker, walking stick, baby carriage and stroller, and/or snow shovel.

U.S. Pat. No. 7,119,304 to Meyers discloses a heated handgrip. This rechargeable, reusable heated hand grip is designed for use on a ski pole, shovel or other cold weather hand-held tool or object. This heated hand grip constitutes a separate assembly with batteries, a switch and a heating element that surrounds a central core and is placed within an outer casing. The heated handgrip is attached to a ski pole by use of a bushing that is attached to the top of the ski pole by setscrews. The heated hand grip is slid on the bushing, securing it to the ski pole. This sliding action requires that the ski pole, or other device to which the heated handgrip is attached, be straight; not curved. On the other hand, handles of canes, walkers, walking sticks, baby carriages and strollers, and many snow shovels, are generally not straight; but are, instead, curved. Consequently, a hand grip heater of the type disclosed by the '304 patent, cannot be slid-on and secured to the curvilinear handles of canes, walkers, walking sticks, baby carriages and strollers, and many snow shovels. The heated hand grip disclosed by the '304 patent is a removable, separate device; and is therefore not an integral part of a cane, walker, walking stick, baby carriage and stroller, and/or snow shovel.

Additional heated devices disclosed by prior art workers utilize portable heaters and various ceramic heaters. These heated devices do not suggest a heated handle integrated within a cane, walker, walking stick, baby carriage and stroller, and/or snow shovel. For Example: U.S. Pat. No. 4,210,073 to Weiss discloses a portable environmental chamber. This environmental chamber is in the form of a dome that covers food and has an internal electrical heater that keeps the food warm. The '073 patent does not disclose or suggest a cane, walker, walking stick, baby carriage and stroller, and/or snow shovel having a heated handle integrated therein. Foreign Patent Publication No JP6203947 to Tsumoru discloses a ceramic heater. This ceramic heater is a carbon based heater wherein conductive carbon powder is perfectly or partially covered over an insulating ceramic inner part. Such a structure forms a general purpose ceramic heater. The '947 patent does not disclose a heater in the handle of a cane, walker, walking stick, baby carriage and stroller, and/or snow shovel.

There remains a need in the art for a heated handle integrated within a cane, walker, walking stick, baby carriage and stroller, and/or snow shovel. Also needed is a cane, walker, walking stick, baby carriage and stroller, and/or snow shovel having integrated therein a heated handle that can readily be switched on by the user to prevent hand contact with a cold handle thereof; and which will maintain a warm temperature on the user's hand when the user is utilizing the cane, walker, walking stick, baby carriage/stroller, and/or snow shovel in cold weather.

### SUMMARY OF THE INVENTION

The present invention provides a heated handle construction that is integral with a cane, walker, walking stick, snow shovel, baby carriage and/stroller. The heated handle within the cane, walker, walking stick, baby carriage and stroller, and/or snow shovel can readily be switched on in advance of use to prevent hand contact with a cold handle before a warmer handle temperature is achieved. Warmth is maintained on the user's hands while the user is walking in low-temperature environments, such as those encountered during fall and winter. Moreover, the warming effect on the user's hands provides comfort and relieves pain otherwise encountered by individuals with arthritic hands.

Broadly stated, the heated handle construction includes an integral stem portion having a distal end and a proximal end. Additionally, the integral stem portion comprises a handle located on the proximal end, a central shaft, and a bearing member located on the distal end thereof. The central shaft is appointed for retaining a plurality of batteries. The handle portion is constructed from a thermally insulating material and is wrapped with integral heating elements to adjust the handle to a desired temperature level. The batteries are connected in series and power the heating element through an on-off switch located on the cane, walker, walking stick, snow shovel, or baby carriage. As the switch is turned to the on position, the handle is warmed efficiently to raise the handle to a warm temperature level. As a result, the cane, stroller, or shovel provides a heated handle that is warm to the touch even during use at low temperatures when walking in wintry weather.

### BRIEF DESCRIPTION OF DRAWINGS

The invention will be more fully understood and further advantages will become apparent when reference is had to the following detailed description and the accompanying drawings, in which:

FIG. 1 is a cross-sectional side view of a walking stick or cane with the heated handle construction integrated therein, illustrating the details of the heater arrangement in the handle;

FIG. 1.1 illustrates the details of an insulating ceramic, wood or polymeric material of a handle wrapped with heating elements;

FIG. 1.2 illustrates placement of an insulating foam material between the insulating handle and the wrapped heating elements;

FIG. 1.3 illustrates placement of an infrared reflective foil or membrane between the heating element and the insulating foam material;

FIG. 1.4 illustrates an on-off switch with selectable heat delivery control;

FIG. 2 illustrates a side view of a walker with the heated handle construction integrated therein;

FIG. 3 illustrates a front view of a snow shovel with the heated handle construction integrated therein; and

FIG. 4 illustrates a side view of a stroller with the heated handle construction integrated therein.

### DESCRIPTION OF THE PREFERRED EMBODIMENTS

This invention relates to a heated handle construction for integration into a cane, walker, walking stick, snow shovel, baby carriage or stroller. Briefly stated, the heated handle construction warms a user's hands while walking or working in frigid or cool temperatures. In the absence of the present invention, the handle temperature of canes, walkers, walking sticks, snow shovels, baby carriages and strollers tends to reach the ambient temperature. Consequently, the handle becomes uncomfortable to grasp, especially in cold environments. In accordance with the present invention, the handle of the cane, walker, walking stick, snow shovel, baby carriage or stroller is provided with a heating element that raises the temperature of the handle surface to substantially the temperature of the hand, allowing the user to grip the handle with minimal discomfort. A warming effect on the user's hands is thereby produced, aiding comfort and relieving pain for individuals with arthritic hands.

Typically, the handle of the cane, walker, walking stick, snow shovel, baby carriage and/stroller is made from an insulating body such as a ceramic, wood or polymeric molded material. Due to the insulating character of the heated handle construction, its heating rate and cooling rate are very small. That is to say, the heated handle construction takes a long time to heat or cool. In a preferred embodiment, the heated handle construction is first wrapped with an insulating polymeric foam material, which is highly flexible and provides a soft cushiony feel to the handle. The plastic material in itself is highly insulating and the presence of closed cells of entrapped air provides additional insulation. This flexible foam is wrapped with a heating tape. The heating tape comprises a plurality of 25 micrometer diameter wires wound or laid in a zig zag pattern, and entrapped in a polymeric adhesive sheet. Such heating tapes are available from MINCO, and are described in detail at http://www.minco.com/uploadedFiles/Products/Thermofoil Heaters/aa30-transparent_htrs.pdf. Alternatively, the heating tape may be a thin sheet of Grafoil, which has a resistivity, typically in the range of 1 to 8×10-4 ohm-inches that is approximately 5 to 25 times as that of a metal. Such Grafoil heating tapes are marketed by Q-foil, and are described in detail at http://www.egc-ent.com/html/qfoil.html. These thin flexible graphite foils are embedded in a plastic layer that may be adhesively coated. This thin polymeric coating on thermofoil heaters or Q-foil heaters protects the internal components of the handle while, at the same time, facilitating delivery of generated heat to the hand of the user. Owing to the insulating character of the handle and the use of insulating flexible polymeric foam, the heat generated is not lost or dissipated within the mass of the handle. The insulating foam cushions the handle, providing a comfortable grip without subjecting the wrapped heating elements to a sharp curvature. A sharp curvature typically has a small curvature radius and can potentially fracture a 25 micrometer heating wire or crack thin sheets of graphite foil. In the case of thermofoil heaters, which use 25 micrometer wires, a reflective metallic sheet or membrane may be inserted between the thermofoil element and the flexible polymeric foam to direct the infrared radiation from the heater to the hand of the user. The membrane may be a sheet of metal or a metallized polymeric sheet.

The heating element is connected through a user operated switch to a set of batteries connected in series. The batteries are contained in the stem of the heated handle of the cane, walker, stroller and/or snow shovel. Preferably, the batteries are rechargeable and deliver a combined voltage of 12 volts. With this voltage, the batteries can be easily charged using a charger connected to a house voltage outlet or directly charged by the cigarette lighter of a car or a van. In a preferred embodiment, the user operated switch may have two positions. One of the switch positions can be used to drain the rechargeable battery that supplies power to the heating elements, or to use the cigarette lighter connection. In an alternate embodiment, the switch may include multiple positions delivering 50% or 100% of the heating current to the heating elements.

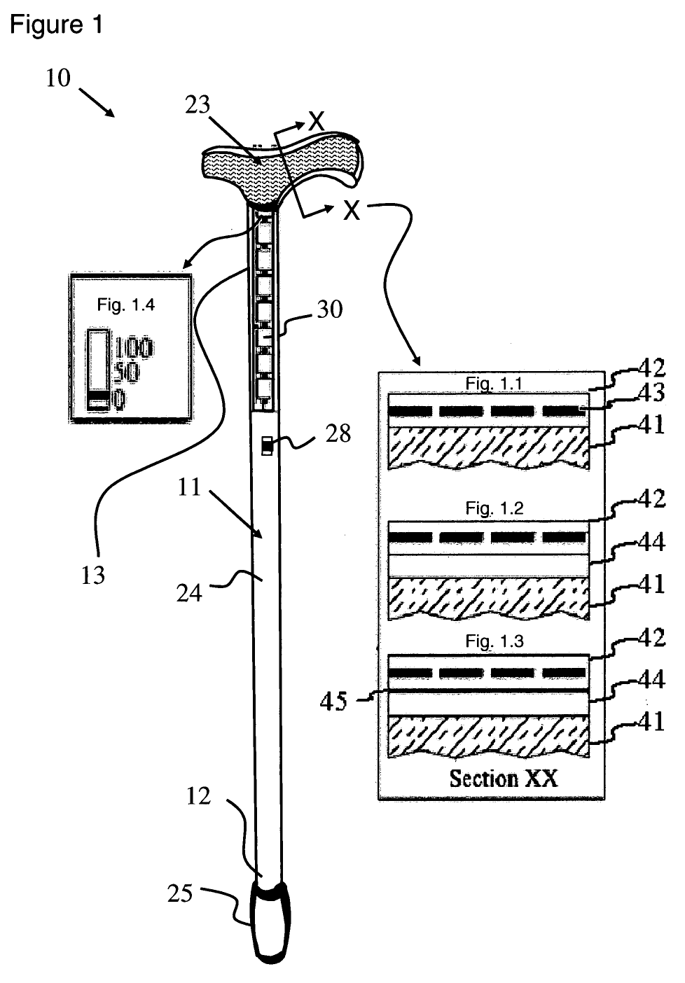

FIG. 1 illustrates generally at 10 a cross-sectional side view of a walking stick or cane with the heated handle construction integrated therein. The walking stick 10 includes an integral stem portion 11 having a distal end 12 and a proximal end 13. Stem portion 11 further includes a handle 23 located on proximal end 13, a central shaft 24, and a bearing member 25 located on distal end 12. Herein, bearing member 25 is a support pad or cushion as is typically utilized at the end of canes, walking sticks, walkers, and the like. An on/off switch is shown at 28. Power means 30 comprises a plurality of batteries incorporated in the central shaft 24. The batteries/power means 30 are connected in series and power a heating element through the on-off switch 28 located on the cane, walker, walking stick 10, snow shovel, or baby carriage. As switch 28 is turned to the on position, handle 23 is warmed efficiently to raise handle 23 to a warm temperature level. As a result the cane/walking stick 10, stroller, or shovel provides a heated handle 23 that is warm to the touch even during use at low temperatures outside when walking in wintry weather.

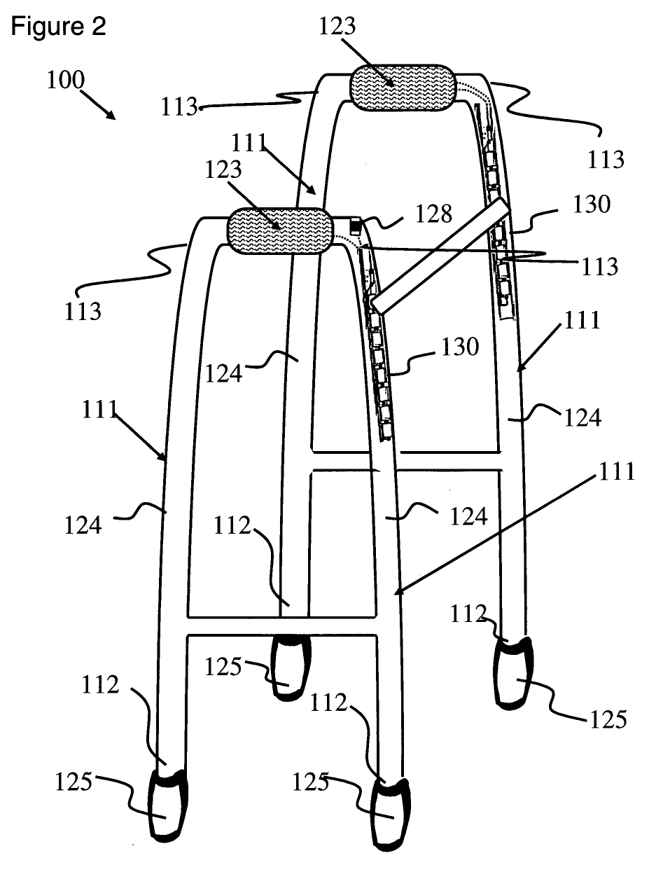

FIGS. 1.1-1.4 illustrate the details of the heated handle construction as utilized in walking stick 10 (as well as the stroller, walker, and shovel discussed hereinafter). Particularly: FIG. 1.1 illustrates the details of an insulating ceramic, wood or polymeric material of a handle wrapped with heating elements; FIG. 1.2 illustrates placement of an insulating foam material between the insulating handle and the wrapped heating elements; FIG. 1.3 illustrates placement of an infrared reflective foil or membrane between the heating element and the insulating foam material; and FIG. 1.4 illustrates an on-off switch with selectable heat delivery control. The heated handle is constructed from a thermally insulating material and is wrapped with integral heating elements to adjust the handle to a desired temperature level. Handle 23 (123, 223, and 323 via FIGS. 2, 3, and 4, respectively) has a central core made from an insulating ceramic, wood or polymeric material 41. In the first embodiment of the invention shown in FIG. 1.1, the heating element 42 is wrapped on the ceramic or polymeric insulating core. The heating element comprises a set of metallic fine wires or Grafoil heaters 43 present in the encapsulated polymer of the heater. The second embodiment of the invention is shown in FIG. 1.2 wherein a flexible foam of polymeric material 44 which has air cells providing insulation is inserted between the ceramic or polymeric core 41 and the wrapped heating element 42. In the third embodiment of the invention, an infrared reflective metallic element 45 is inserted between the heating element 42 and the flexible foam of polymeric material 44. This infrared reflective metallic element 45 reflects the heat emitted by the heater 42 towards the hand of the user and reduces its leakage into the ceramic or polymeric core 41. While the placement of the infrared reflective element shown in FIG. 1.3 is between the heating element and the flexible insulating foam material, it should be understood that the infrared reflective element may alternatively be placed between the heating element and the insulating handle without the use of flexible insulating foam. The stem portion of the cane, shovel, or stroller houses the power source which is shown to be series connected eight 1.5 volt cell adapted to produce a voltage of 12 volts. The series connected batteries power the heating elements through an on/off switch 28, the details of which are shown in FIG. 1.4. The switch, in addition to on and off positions, has a low heat intensity level at 50% value, as shown. A socket 46 is provided for connecting to the cigarette lighter connection in a car or SUV, enabling charging of rechargeable batteries 30 or the use of cigarette lighter power to drive the heating elements 42.

A variety of shaped or sized heated handle constructions can be utilized, such as “J” curved handles such as in the shape of the traditional cane, a straight handle, a finger-grooved handle, a semi U-shaped bar such as in the shape of a baby stroller handles, and the like. Optionally, the external surface of the heated handle construction may be substantially water proof and thereby resist accumulation and penetration of water on the handle portion and the heating element. In particular, the external surface may be coated with a material selected from a group consisting of wax, silicone or Teflon (polytetrafluroethylene). A heightened handle temperature radiates heat into the hands of the user, providing relief to those suffering from arthritis and carpal tunnel syndrome

FIG. 2 illustrates a side view of a walker with the heated handle construction integrated therein. An integral stem portion is constructed as an inverted U-shape having parallel legs to form a walker device, shown generally at 100. The heated handle construction is shown in FIGS. 1.1-1.4 discussed hereinabove. Walker 100 includes an integral stem portion 111 having a distal end 112 and a proximal end 113. Stem portion 111 further includes a handle 123 located on proximal end 113, a central shaft 124, and a bearing member 125 located on distal end 112. Bearing member 125 is a support pad or cushion as is typically utilized at the end of canes, walking sticks, walkers, and the like. An on/off switch is shown at 128 for actuating power means 130 comprising a plurality of batteries incorporated in the central shaft 124 connected in series and power a heating element through the on-off switch 128 located on the walker's legs. Dual power means 130 are provided, as shown; alternatively there may be a single power means 130 located in one of the legs or in proximity to the handles 123.

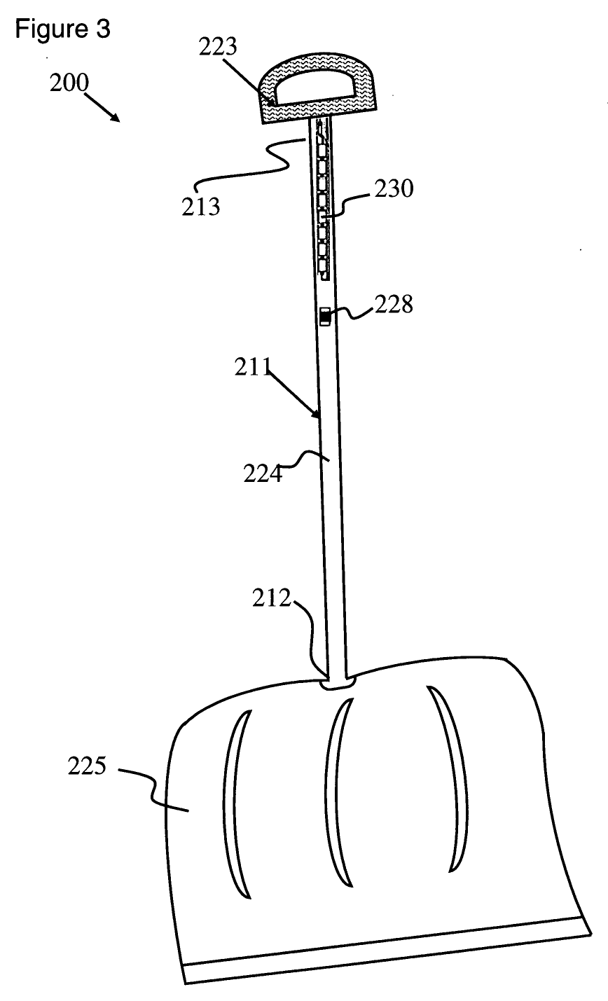

FIG. 3 illustrates a front view of a snow shovel with the heated handle construction integrated therein, shown generally at 200. The heated handle construction is shown in FIGS. 1.1-1.4 discussed hereinabove. Shovel 200 includes an integral stem portion 211 having a distal end 212 with a bearing member 125, herein shown as a shovel blade. A. proximal end 213 is provided with a handle 223. A central shaft 224 includes an on/off switch is shown at 228 for actuating power means 230 comprising a plurality of batteries incorporated in the central shaft 224 connected in series and power a heating element through the on-off switch 228.

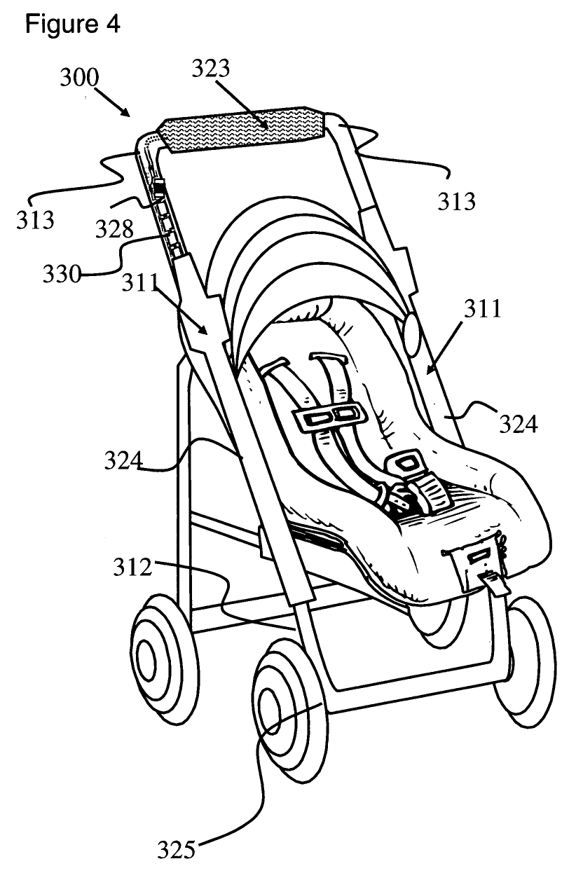

FIG. 4 illustrates a side view of a stroller with the heated handle construction integrated therein, shown generally at 300. The heated handle construction is shown in FIGS. 1.1-1.4 discussed hereinabove. Baby Carriage 300 includes dual integral stem portions 311 having a distal end 312 with a bearing member 325, herein attached to wheels. Each of the proximal ends 313 converge to provide a handle 223 having a u-shape. Alternatively, the proximal ends 414 may not converge, as with some strollers, and therefore each handle includes the ability to be heated via as described herein. A central shaft 324 includes an on/off switch 328, which is shown on one of the integral stem portions 311, for actuating power means 330. Power means 330 comprises a plurality of batteries incorporated in the central shaft 324 of one of the integral stem portions 311 (optionally, both stem portions may include the power means) connected in series and power a heating element through the on-off switch 228 and leading to each handle 323 on each of the integral stem portions 311.

The heated handle construction for integration into a cane, walker, walking stick, snow shovel, baby carriage or stroller of the present invention comprises, in combination, the following salient features:
i) an integral stem portion having a distal end and a proximal end;
ii) the integral stem portion comprising a handle located on the proximal end, a central shaft, and a bearing member located on the distal end;
iii) the central shaft being appointed for retaining a plurality of batteries, preferably rechargeable batteries;
iv) the handle portion being constructed from a thermally insulating material;
v) the handle portion being wrapped with integral heating elements to adjust said handle to a temperature level;
vi) the batteries being connected in series and powering said heating element through an on-off switch;
vii) optionally, the handle's external surface being substantially water proof and thereby resisting accumulation and penetration of water on the handle portion and the heating element;
viii) the handle portion being constructed from an insulating polymeric, wood or ceramic material that is wrapped with integral heating elements;
ix) the heating elements comprising flexible tape or flexible strip;
x) optionally a foam of flexible tape being disposed between the insulating polymeric, wood or ceramic material and said heating elements, limiting heat transmission to the insulating polymeric, wood or ceramic material;
xi) optionally an infrared reflective metallic strip being placed under the heating element to direct infrared heat from heating elements to the hand of the user;
xii) the batteries being connected in series and powering the heating element through an on-off switch that is optionally provided with a heating intensity control;
xiii) optionally the batteries providing 12 volts, thereby matching voltage available in a cigarette lighter terminal of a car or SUV that is appointed for charging the rechargeable batteries;

While the integrated heated handle is disclosed with respect to a handle of a cane, walker, walking stick, snow shovel, baby carriage or stroller, the same heated handle configuration may be used for heating integral handles of other appliances, and tools, such as ice scrapers, snow blowers, ski poles, and the like.

Having thus described the invention in rather full detail, it will be understood that such detail need not be strictly adhered to, but that additional changes and modifications may suggest themselves to one skilled in the art. For example, the distal end of the cane or walker could have the shape of a palm grip, which may optionally be constructed for left-handed or right-handed use. Depending upon the size of the heated handle construction, there may be a need for two distal ends and/or two proximal ends which, if present, may require an additional heat source. A double baby stroller represents an example where, owing to the additional width of the handle, the stroller may profitably utilize a heated handle construction having two proximal ends and/or two distal ends. Such modifications are intended to fall within the scope of the invention as defined by the subjoined claims.

What is claimed is:

1. A heated handle construction, comprising:
a. an integral stem portion having a distal end and a proximal end, said integral stem portion comprising a handle located on said proximal end, a central shaft, and a bearing member located on said distal end;
b. said central shaft being appointed for retaining a plurality of batteries;
c. said handle portion being constructed from a thermally insulating material;
d. said handle portion being wrapped with integral heating elements to adjust said handle to a temperature level;
e. said batteries being connected in series and powering said heating element through an on-off switch;
whereby said handle is warmed efficiently to thereby raise said handle to said temperature level that provides a comfortable grip for the user.

2. A heated handle construction as recited by claim 1, wherein said thermally insulating material is selected from a group consisting of molded polymer, wood and ceramic.

3. A heated handle construction as recited by claim 1, wherein said central shaft has a hollow cavity and retains batteries within said cavity.

4. A heated handle construction as recited by claim 1, wherein said batteries are rechargeable.

5. A heated handle construction as recited by claim 1, wherein said integral heating element is a wound flexible tape.

6. A heated handle construction as recited by claim 5, wherein said wound flexible tape has zig zag pattern of 25 micrometer wire.

7. A heated handle construction as recited by claim 1, wherein said integral heating element is a wound flexible strip.

8. A heated handle construction as recited by claim 7, wherein said wound flexible strip is a graphite foil strip.

9. A heated handle construction as recited by claim 1, wherein an infrared reflective membrane or foil is inserted between said integral heating element and said insulating material of said handle.

10. A heated handle construction as recited by claim 9, wherein said infrared reflective membrane or foil is a metallic foil.

11. A heated handle construction as recited by claim 9, wherein said infrared reflective membrane or foil is a metallized polymeric sheet.

12. A heated handle construction as recited by claim 1, wherein a thermally insulating flexible foam tape is inserted between said thermally insulating material of the handle and said integral heating element to thereby provide a cushioned grip on said handle.

13. A heated handle construction as recited by claim 12, wherein an infrared reflective membrane or foil is inserted between said integral heating element and said thermally insulating flexible foam tape.

14. A heated handle construction as recited by claim 1, wherein said batteries have an open circuit voltage of 12 V and are chargeable from the cigarette lighter connection in a car or SUV.

15. A heated handle construction as recited by claim 1, wherein said batteries have an open circuit voltage of 12 V and said heating elements are powered from the cigarette lighter connection within a car or SUV.

16. A heated handle construction as recited by claim 1, wherein said on-off switch additionally comprises 50% and 100% power settings.

17. A heated handle construction as recited by claim 1, wherein said handle is a finger grooved handle.

18. A heated handle construction as recited by claim 1, wherein said handle is a “J” curved handle.

19. A heated handle construction as recited by claim 1, wherein said handle is a straight handle.

20. A heated handle construction as recited by claim 1, wherein said handle is a semi “U-shaped” bar.

21. A heated handle construction as recited by claim 1, wherein said integral stem portion is part of a cane or walking stick.

22. A heated handle construction as recited by claim 1, wherein said integral stem portion is constructed as an inverted U-shape having parallel legs to form a walker device.

23. A heated handle construction as recited by claim 1, wherein said integral stem portion is part of a snow shovel.

24. A heated handle construction as recited by claim 1, wherein said integral stem portion is connected to and integrated within a stroller, baby carriage, or baby pram.

25. A heated handle construction as recited by claim 1, wherein said handle portion comprises an external surface and an internal surface, wherein said external surface of said handle portion is water proof and thereby resisting accumulation and penetration of water on said handle portion and said heating element.

26. A heated handle construction as recited by claim 25, wherein said external surface is coated with a material selected from a group consisting of wax, silicone or Teflon (polytetrafluroethylene).
